(19) United States
(12) Patent Application Publication
(10) Pub. No.: US 2004/0125144 A1
(43) Pub. Date: Jul. 1, 2004

(54) Integrated management method and system for multimedia contents

(75) Inventor: Sung-Min Yoon, Euiwang City (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon City (KR)

(21) Appl. No.: 10/600,544

(22) Filed: Jun. 23, 2003

(30) Foreign Application Priority Data
Dec. 30, 2002 (KR) 2002-86530

(51) Int. Cl. G09G 5/00

(52) U.S. Cl. 345/769

(57) ABSTRACT

An integrated management method for multimedia contents integratedly managing a plurality of multimedia players to replay multimedia files, with reference to file information of the multimedia files registered in a predetermined file information database (DB). The integrated management method includes activating a file search window in which a list of the multimedia files is displayed, and a file information registration window in which a list of the file information of the multimedia files is displayed. The integrated management method also includes registering the file information of the multimedia files in the file information DB by dragging and dropping the multimedia files displayed in the file search window to the file information registration window. Thus, provided are an integrated management method and an integrated management system for multimedia contents enabling file information of a multimedia file to be conveniently registered through the integrated manager for the multimedia contents.

### CROSS-REFERENCE TO RELATED APPLICATIONS

This application claims the benefit of Korean Patent Application No. 2002-86530, filed Dec. 30, 2002, in the Korean Intellectual Property Office, the disclosure of which is incorporated herein by reference.

### BACKGROUND OF THE INVENTION

1. Field of the Invention

The present invention relates to an integrated management method and an integrated management system for multimedia contents, and more particularly, to an integrated management method and an integrated management system for multimedia contents enabling file information of multimedia files to be conveniently registered through the integrated manager for the multimedia contents.

2. Description of the Related Art

Nowadays, a computer having higher performance and capacity has been produced. Accordingly, working space using the computer has been expanded. The expansion of the working space using the computer has been more and more accentuated along with development of digital technologies.

For example, the WINDOWS MEDIA PLAYER developed by MICROSOFT replays various kinds of audio files or video files, it is possible to watch TV through the computer by mounting a TV card on the computer, and it is also possible to view and to edit digital pictures. Like this, a user can access various multimedia environments through the computer.

In the meanwhile, an integrated manager for multimedia contents to integratedly manage multimedia engines, such as the TV card and a multimedia player (like the WINDOWS MEDIA PLAYER), replaying multimedia files, has been developed. The integrated manager for the multimedia contents is provided as an application based on an operating system of the computer or as a part of the operating system of the computer.

By way of an example of the integrated manager for the multimedia contents, the WINDOWS XP MEDIA CENTER developed by MICROSOFT cooperates with the multimedia player engine, such as a media player, a image viewer, a TV card, a DVD player, and the like, and integratedly manages them, to thereby provide a user interface conveniently used in the multimedia environments through the computer.

In the case that a user intends to replay a multimedia file through the integrated manager for the multimedia contents, the user must register a multimedia file in a multimedia player associated with the integrated manager for the multimedia contents, and file information of a registered multimedia file is stored in a predetermined file information DB (database). The integrated manager for the multimedia contents uses the file information of the file information DB in common. The user can replay the multimedia file by operating the multimedia player through the integrated manager for the multimedia contents.

However, there is a problem that registration procedures of multimedia files are different according to the multimedia contents in the case of the conventional integrated manager for the multimedia contents. For example, in the case of the WINDOWS MEDIA PLAYER, to register audio files or video files, the WINDOWS MEDIA PLAYER is activated, and then the audio files or video files should be registered by using a file registration interface provided by the WINDOWS MEDIA PLAYER. Also, in the case of the image viewer, to register image files, a search window in WINDOWS is activated, and then the image files should be registered by being transmitted/stored in a certain directory. In the conventional method, there is a problem that the conventional integrated manager for the multimedia contents must undergo a separate registration procedure according to the multimedia contents.

### SUMMARY OF THE INVENTION

Accordingly, it is an aspect of the present invention to provide an integrated management method and an integrated management system for multimedia contents enabling file information of a multimedia file to be conveniently registered through the integrated manager for the multimedia contents.

Additional aspects and advantages of the present invention will be set forth in part in the description that follows and, in part, will be obvious form the description, or may be learned by practicing the present invention.

The foregoing and/or other aspects of the present invention are achieved by providing an integrated management method for multimedia contents integratedly managing a plurality of multimedia players to replay multimedia files, comprising: activating a file search window in which a list of multimedia files is displayed, and a file information registration window in which a list of file information of the multimedia files is displayed, the file information being registered in a file information database (DB); and registering the file information of the multimedia files in the file information DB by dragging and dropping the multimedia files displayed in the file search window to the file information registration window.

In an embodiment of the present invention, the registering the file information comprises listing file information of dragged/dropped multimedia files.

In an embodiment of the present invention, the file information registration window comprises at least one of a registration windows according to contents, which is separated according to types of the multimedia files, and the activating the file information registration window comprises selecting one of the registration windows according to contents and activating a selected registration window according to contents.

In an embodiment of the present invention, the file information DB comprises at least one file information DB according to contents corresponding to the registration window according to contents, and the registering the file information comprises registering the file information in the file information DB according to contents corresponding to types of the multimedia files.

In an embodiment of the present invention, registering the file information further comprises: inspecting whether one of the multimedia files that is dragged and dropped in an activated registration window according to contents has a file type that is able to be registered in the activated registration window according to contents; and displaying an error message when one of the multimedia files that is dragged and dropped in the activated registration window according to contents does not have a file type that is able to be registered in the activated registration window according to contents.

In an embodiment of the present invention, the inspecting comprises examining an extension of the multimedia file.

In an embodiment of the present invention, the file information of the multimedia files includes address information of the multimedia files.

In an embodiment of the present invention, the file information of the multimedia files includes Meta information of the multimedia files.

In an embodiment of the present invention, registering the file information comprises inputting the file information of the dragged/dropped multimedia file when the dragged/dropped multimedia file does not include the Meta information.

The foregoing and other aspects of the present invention are also achieved by providing an integrated management system for multimedia contents, comprising: a file storing part to store multimedia files; a file information database (DB) in which file information of the multimedia files is registered; at least one multimedia player to replay the multimedia files corresponding to the file information of the multimedia files registered in the file information DB; and an integrated manager for multimedia contents that provides a file registration interface to register the file information of the multimedia files in the file information DB, and to integratedly manage the at least one multimedia player.

In an embodiment of the present invention, the file registration interface of the integrated manager for multimedia contents comprises: a file search window on which the multimedia files stored in the file storing part are displayed; and a file information registration window on which the file information of the multimedia files stored in the file information DB is displayed.

In an embodiment of the present invention, the file information of the multimedia files is registered in the file information DB by dragging and dropping the multimedia files displayed in the file search window to the file information registration window.

In an embodiment of the present invention, the file information registration window is activated according to a user's selection and has at least one registration window according to contents separated in accordance with types of the multimedia files, and the file registration interface displays an error message when one of the multimedia files that is dragged and dropped to an activated registration window according to contents does not have a file type that is able to be registered in the activated registration window according to contents.

In an embodiment of the present invention, the file information DB includes a file information DB according to contents corresponding to each registration window according to contents, and the file information is registered in each file information DB according to contents through a corresponding registration window according to contents.

In an embodiment of the present invention, the file information of the multimedia files includes address information of the multimedia files.

In an embodiment of the present invention, the file information of the multimedia files includes Meta information of the multimedia files.

In an embodiment of the present invention, the file registration interface provides a file information input window to input the file information of dragged/dropped multimedia files when the dragged/dropped multimedia files does not include the Meta information.

### BRIEF DESCRIPTION OF THE DRAWINGS

These and/or other aspects and advantages of the present invention will become apparent and more readily appreciated from the following description of the embodiments, taken in conjunction with the accompany drawings of which:

FIG. 1 is a control block diagram of an integrated management system for multimedia contents according to an embodiment of the present invention;

FIG. 2 is a view illustrating an initial window of the integrated management system for the multimedia contents of FIG. 1;

FIG. 3 is a view illustrating a picture of a file registration interface according to an embodiment of the present invention;

FIG. 4 is a view illustrating a picture of the file registration interface in which an error message is displayed; and

FIG. 5 is control block diagram of an integrated management method for the multimedia contents according to an embodiment of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout. The embodiments are described below in order to explain the present invention by referring to the figures.

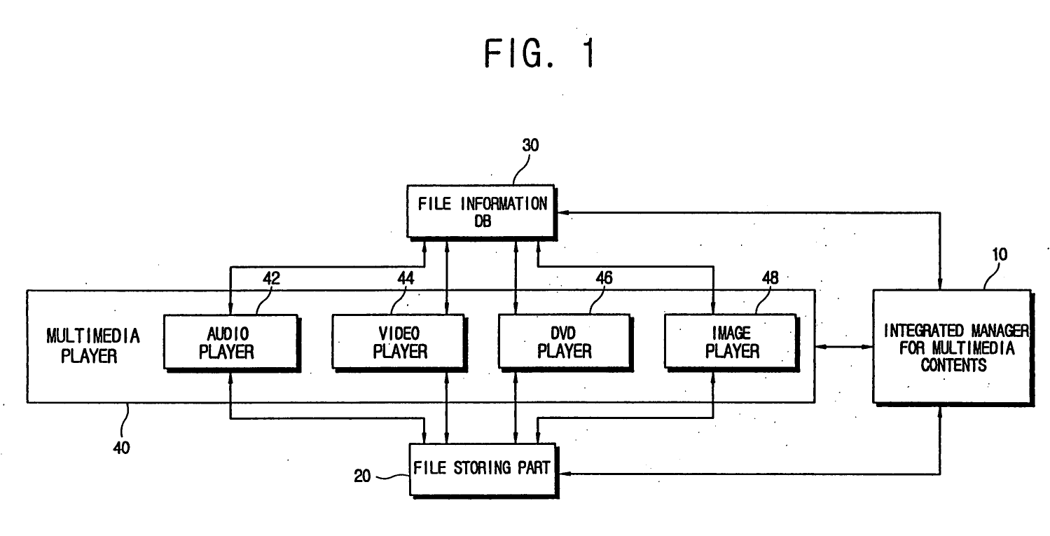

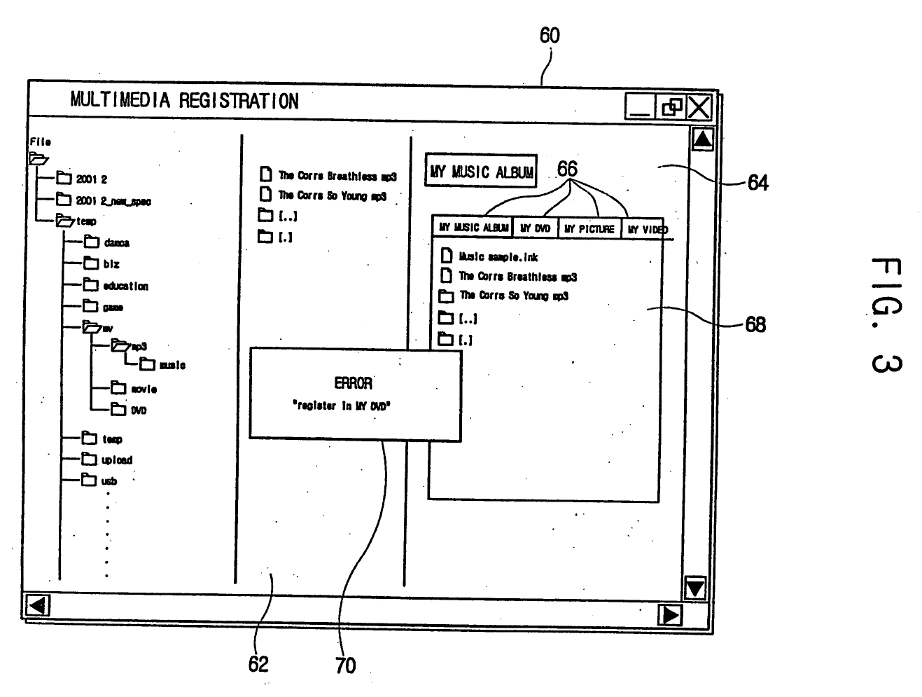

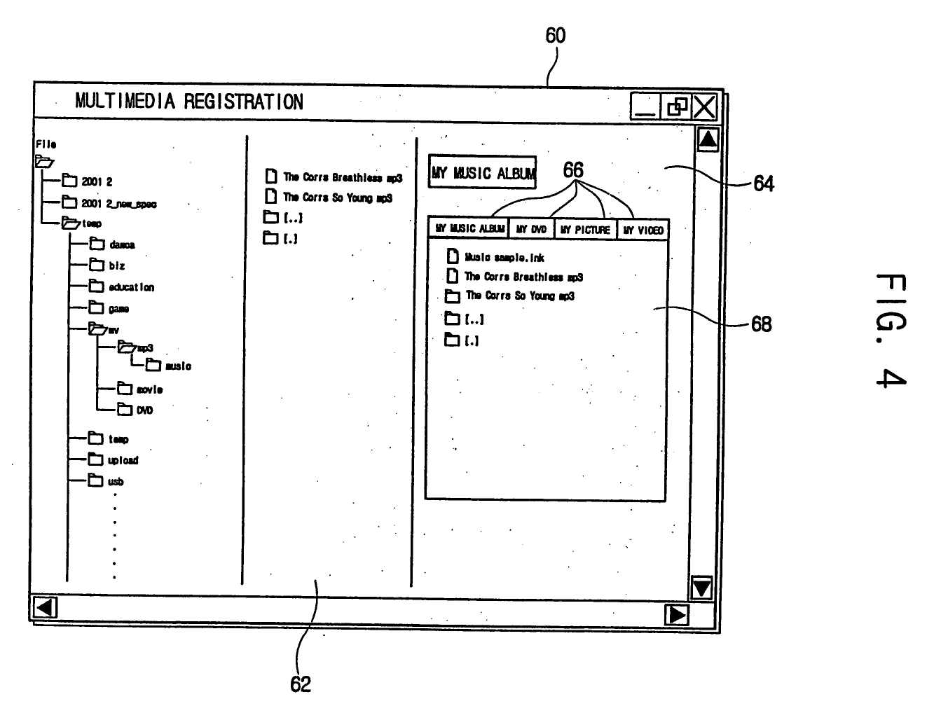

FIG. 1 is a control block diagram of an integrated management system for multimedia contents according to an embodiment of the present invention. As shown in FIG. 1, the integrated management system for the multimedia contents comprises: a file storing part 20 storing multimedia files; a file information database (DB) 30 in which file information of the multimedia files is registered; a plurality of multimedia players 40 (only one is illustrated in FIG. 1) replaying multimedia files corresponding to the file information of the multimedia files registered in the file information DB 30; and an integrated manager for the multimedia contents 10 providing a file registration interface 60 (illustrated in FIGS. 3 and 4) for registering the file information of the multimedia files in the file information DB 30 and integratedly managing the multimedia player 40. However, embodiments of the present invention are not limited to a plurality of multimedia players 40, as only at least one is possible.

The file storing part 20, as a readable and writable memory, stores various kinds of multimedia files, such as audio files, video files, image files, and the like. As examples of the audio files, .mp3 files, .midi files, .wav files, .wma files and so on can be referred to. As examples of the video files, .avi files, .mov files, .ra files and so on can be referred to. As examples of the image files, .bmp files, .jpeg files, .tif files, .pdf files and so on can be referred to. The present invention is not limited to the above-mentioned file types, as any other file types may be used. For example, text file types may also be used.

The file information of a multimedia file is registered in the file information DB 30, and stored in a predetermined memory. Herein, the file information DB 30 can be classified into the file information DB 30 according to contents corresponding to a registration window according to contents 68 (to be described later) on the basis of multimedia file types. The file information DB 30 according to respective contents is stored in a respective directory of the memory, and thus can be displayed in the corresponding registration window according to contents 68.

In an embodiment, the file information of the multimedia file registered in the file information DB 30 includes Meta data like address information of the multimedia files. By way of an example of the Meta data, there is an ID3 tag information standardly used to append information of, for example, a music title, an author, a music channel, and the like in the .mp3 files.

In an embodiment, each of the plurality of multimedia players 40 includes an audio player 42 to replay the audio files, a video player 44 to replay the video files, an image player 48 to display images of selected the image files, a DVD player 46 to replay the DVD files, and so on. Each of the plurality of multimedia players 40 can be provided as a separate application, or as an integrated application capable of replaying two or more contents.

The plurality of multimedia players 40 are integratedly managed by the integrated manager for multimedia contents 10, access the file storing part 20 storing corresponding multimedia files with reference to the file information of the multimedia file registered in the file information DB 30, and replay the multimedia files.

The integrated manager for the multimedia contents 10 integratedly manages multimedia. Herein, the term “integrated management” means that a user interface allowing a user to play respective players of the plurality of multimedia players 40 not separately but at one space is provided. That is, a user can play each of the plurality of multimedia players 40 through the user interface provided by the integrated manager for multimedia contents 10 without directly accessing each of the plurality of multimedia players 40. The integrated manager for multimedia contents 10, according to the present invention, is provided as an application based on an operating system or a part of the operating system.

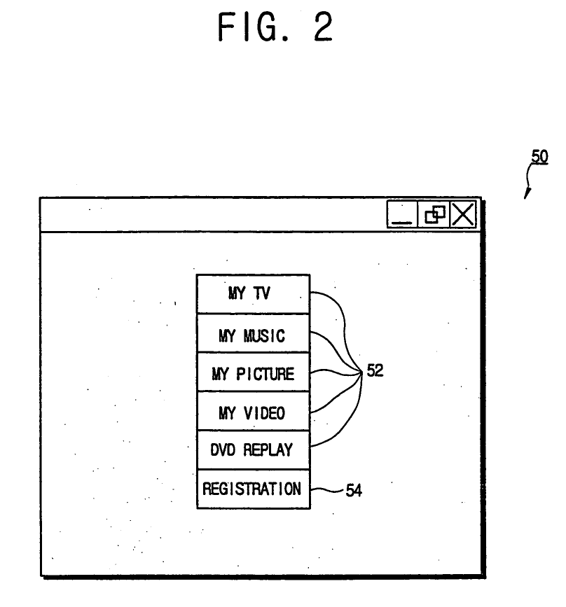

FIG. 2 is an exemplary view illustrating an initial window displayed when the integrated management system for the multimedia contents 10, according to embodiments of the present invention, is activated. A plurality of contents selection buttons 52 for selecting the multimedia contents is displayed in the initial window 50 of the integrated manager for the multimedia contents 10. In each of the plurality of contents selection buttons 52, characters or pictures, such as “MY TV”, “MY MUSIC”, “MY PICTURE”, “MY VIDEO”, “MY DVD”, and the like, to represent function of each of the plurality of contents selection buttons 52 can be displayed. However, embodiments of the present invention are not limited to the number, shape, appearance, or order of the choices in contents selection button 52 as illustrated in FIG. 2. For example, if a user clicks the contents selection button 52 choice in which “my music” is displayed, the integrated manager for the multimedia contents 10 provides an interface for replaying the audio files in which a music file list is displayed.

Also, in the initial window of the integrated manager for the multimedia contents 10 is provided a registration button 54. If a user clicks the registration button 54, the integrated manager for the multimedia contents 10 provides a file registration interface 60 (illustrated in FIGS. 3 and 4) for registering the multimedia files.

FIG. 3 is an exemplary view illustrating the file registration interface 60 according an embodiment of to the present invention. As shown in FIG. 3, the file registration interface 60 according to the present invention comprises a file search window 62 on which the multimedia files stored in the file storing part 20 are displayed, and a file information registration window 64 in which the file information of the multimedia files stored in the file information DB 30 is displayed.

In the file search window 62, a list of files stored in the file storing part 20 is displayed. As to the files displayed in the file search window 62, the multimedia files can be displayed not only alone, but also together with other file types.

In the file information registration window 64, a list of the file information of the multimedia files registered in the file information DB 30 is displayed. Also, the file information registration window 64 comprises a plurality of registration window selecting buttons 66 separated according to the multimedia contents, and a registration window according to contents 68 activated on selection of one of the plurality of registration window selecting buttons 66. The registration window according to contents 68 is activated in the case that a user clicks a corresponding registration window selecting button 66, while a registration window according to contents 68 is hidden when none of the plurality of registration window selecting buttons 66 is selected.

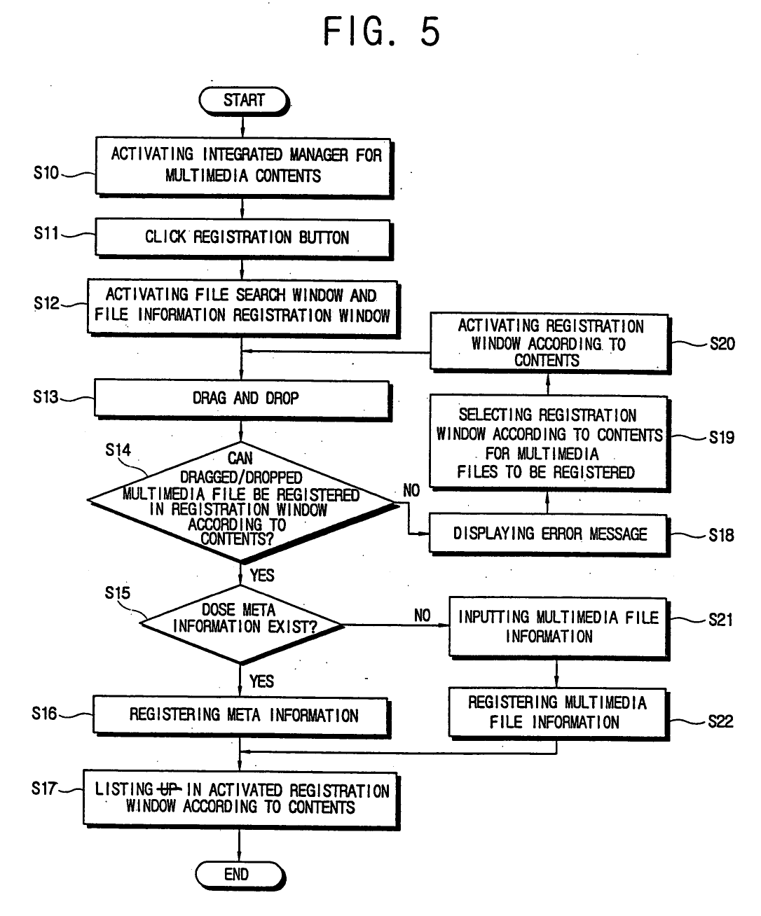

With the above configuration, an integrated management method for the multimedia contents according to the present invention, as illustrated in FIG. 5, will be described as follows.

FIG. 5 is a control block diagram of an integrated management method for the multimedia contents according to an embodiment of the present invention.

At first, if a user executes the integrated manager for the multimedia contents 10 (S10), the initial window 50 is displayed. Subsequently, if the user selects the registration button 54 displayed in the initial window 50 in order to register the multimedia files (S11), the file registration interface 60 comprising the file search window 62 and the file information registration window 64 is activated (S12).

The user locates the multimedia file to register in the file search window 62, and drags and drops the multimedia file from the file search window 62 to the activated registration window according to contents 68. Herein, the integrated manager for the multimedia contents 10 inspects whether a dragged/dropped multimedia file has a multimedia file type that is able to be registered in the registration window according to contents 68 activated in the file information registration window 64 (S14). In the case that the dragged/dropped multimedia file is not a multimedia file type that is able to be registered, an error message 70 is displayed (as illustrated in FIG. 4) (S18). In an embodiment, the types of the multimedia files can be determined by examining the file extensions.

Subsequently, the user selects (S19) and activates (S20) the registration window according to contents 68 in which the dragged/dropped multimedia files can be registered, on the basis of information of the registration window according to contents 68 in which the dragged/dropped multimedia files can be registered, which is displayed together with the error message 70. The user drags and drops the multimedia file again (S13). Accordingly, the dragged/dropped multimedia file can be registered in the activated registration window according to contents 68.

In the present invention, if the Meta information such as address information is included in the dragged/dropped multimedia file (S15), the Meta information is registered in the file information DB 30 (S16), and the file information of the dragged/dropped multimedia file is listed in the activated registration window according to contents 68 (S17).

Conversely, in the case that the dragged/dropped multimedia file does not include the Meta information (S15), a file information input window for inputting file information of the dragged/dropped multimedia file (not illustrated) can be activated in the file registration interface 60. That is, in the case that an audio file not including ID3 tag information is dragged and dropped, if the user inputs information, such as an author, a genre, and the like, through the file information input window (S21), inputted multimedia file information is registered in the file information DB 30 (S22) and is listed in the activated registration window according to contents 68 (S17).

In the case of replaying the registered multimedia files through the registration process described above, for example, in the case of replaying the audio files, if a user selects the “my music” selection button 52 on the initial window 50 of the integrated manager for the multimedia contents 10, then the integrated manager for the multimedia contents 10 displays an audio replay interface (not shown) for replaying the audio files. Herein, the integrated manager for the multimedia contents 10 displays the file information of the audio file registered in the file information DB 30 in the audio replay interface. If a user selects an audio file to replay, the integrated manager for the multimedia contents 10 transmits the user's selection information to the audio player 42, and the audio player 42 finds and replays the audio file stored in the file storing part 20 by using the address information of the audio file stored in the file information DB 30.

Also, in an embodiment, the file information including the address information of the multimedia file is displayed in the registration window according to contents 68, but only predetermined file information among file information can be displayed.

Further, in an embodiment, the file information DB 30 is stored in a predetermined memory and the multimedia files are stored in the file storing part 20, but the file information DB 30 and the multimedia files can be stored in one storing apparatus such as an HDD.

In the present invention, by providing the file registration interface 60 for registering the file information of the multimedia files in the file information DB 30 and the integrated manager for the multimedia contents 10 to integratedly managing the multimedia applications, a user can register a multimedia file conveniently.

As described above, according to the present invention, provided are an integrated management method and an integrated management system for multimedia contents enabling file information of a multimedia file to be conveniently registered through the integrated manager for the multimedia contents.

The hardware included in the system may include memories, processors, and/or Application Specific Integrated Circuits (“ASICs”). Such memory may include a machine-readable medium on which is stored a set of instructions (i.e., software) embodying any one, or all, of the methodologies described herein. Software can reside, completely or at least partially, within this memory and/or within the processor and/or ASICs. For the purposes of this specification, the term “machine-readable medium” shall be taken to include any mechanism that provides (i.e., stores and/or transmits) information in a form readable by a machine (e.g., a computer). For example, a machine-readable medium includes read only memory (“ROM”), random access memory (“RAM”), magnetic disk storage media, optical storage media, flash memory devices, electrical, optical, acoustical, or other form of propagated signals (e.g., carrier waves, infrared signals, digital signals, etc.), etc.

Although a few embodiments of the present invention have been shown and described, it will be appreciated by those skilled in the art that changes may be made in these embodiments without departing from the principles and spirit of the present invention, the scope of which is defined in the appended claims and their equivalents.

What is claimed is:

1. An integrated management method for multimedia contents integratedly managing a plurality of multimedia players to replay multimedia files, comprising:
activating a file search window in which a list of multimedia files is displayed, and a file information registration window in which a list of file information of the multimedia files is displayed, the file information being registered in a file information database (DB); and
registering the file information of the multimedia files in the file information DB by dragging and dropping the multimedia files displayed in the file search window to the file information registration window.

2. The integrated management method according to claim 1, wherein the registering the file information comprises listing file information of dragged/dropped multimedia files.

3. The integrated management method according to claim 1,
wherein the file information registration window comprises at least one of a registration windows according to contents, which is separated according to types of the multimedia files, and
wherein the activating the file information registration window comprises selecting one of the registration windows according to contents and activating a selected registration window according to contents.

4. The integrated management method according to claim 3,
wherein the file information DB comprises at least one file information DB according to contents corresponding to the registration window according to contents, and
wherein the registering the file information comprises registering the file information in the file information DB according to contents corresponding to types of the multimedia files.

5. The integrated management method according to claim 3, wherein the registering of the file information further comprises:
inspecting whether one of the multimedia files that is dragged and dropped in an activated registration window according to contents has a file type that is able to be registered in the activated registration window according to contents; and
displaying an error message when one of the multimedia files that is dragged and dropped in the activated registration window according to contents does not have a file type that is able to be registered in the activated registration window according to contents.

6. The integrated management method according to claim 5, wherein the inspecting comprises examining an extension of the multimedia file.

7. The integrated management method according to claim 5, wherein the file information of the multimedia files includes address information of the multimedia files.

8. The integrated management method according to claim 5, wherein the file information of the multimedia files includes Meta information of the multimedia files.

9. The integrated management method according to claim 8, wherein the registering of the file information further comprises inputting the file information of the dragged/dropped multimedia file when the dragged/dropped multimedia file does not include the Meta information.

10. An integrated management system for multimedia contents, comprising:
a file storing part to store multimedia files;
a file information database (DB) in which file information of the multimedia files is registered;
at least one multimedia player to replay the multimedia files corresponding to the file information of the multimedia files registered in the file information DB; and
an integrated manager for multimedia contents that provides a file registration interface to register the file information of the multimedia files in the file information DB, and to integratedly manage the at least one multimedia player.

11. The integrated management system according to claim 10, wherein the file registration interface of the integrated manager for multimedia contents comprises:
a file search window on which the multimedia files stored in the file storing part are displayed; and
a file information registration window on which the file information of the multimedia files stored in the file information DB is displayed.

12. The integrated management system according to claim 11, wherein the file information of the multimedia files is registered in the file information DB by dragging and dropping the multimedia files displayed in the file search window to the file information registration window.

13. The integrated management system according to claim 12,
wherein the file information registration window is activated according to a user's selection and has at least one registration window according to contents separated in accordance with types of the multimedia files, and
wherein the file registration interface displays an error message when one of the multimedia files that is dragged and dropped to an activated registration window according to contents does not have a file type that is able to be registered in the activated registration window according to contents.

14. The integrated management system according to claim 13,
wherein the file information DB includes a file information DB according to contents corresponding to each registration window according to contents, and
wherein the file information is registered in each file information DB according to contents through a corresponding registration window according to contents.

15. The integrated management system according to claim 14, wherein the file information of the multimedia files includes address information of the multimedia files.

16. The integrated management system according to claim 14, wherein the file information of the multimedia files includes Meta information of the multimedia files.

17. The integrated management system according to claim 16, wherein the file registration interface provides a file information input window to input the file information of dragged/dropped multimedia files when the dragged/dropped multimedia files does not include the Meta information.

18. A machine-readable medium that provides instructions, which, when executed by a machine, cause the machine to perform operations for integratedly managing a plurality of multimedia players to replay multimedia files comprising:
activating a file search window in which a list of multimedia files is displayed, and a file information registration window in which a list of file information of the multimedia files is displayed, the file information being registered in a file information database (DB); and
registering the file information of the multimedia files in the file information DB by dragging and dropping the multimedia files displayed in the file search window to the file information registration window.

19. The machine-readable medium of claim 18, wherein the registering the file information comprises listing file information of dragged/dropped multimedia files.

20. The machine-readable medium of claim 18,
wherein the file information registration window comprises at least one of a registration windows according to contents, which is separated according to types of the multimedia files, and
wherein the activating the file information registration window comprises selecting one of the registration windows according to contents and activating a selected registration window according to contents.

21. The machine-readable medium of claim 20,
wherein the file information DB comprises at least one file information DB according to contents corresponding to the registration window according to contents, and
wherein the registering the file information comprises registering the file information in the file information DB according to contents corresponding to types of the multimedia files.

22. The machine-readable medium of claim 20, wherein the registering of the file information further comprises:
inspecting whether one of the multimedia files that is dragged and dropped in an activated registration window according to contents has a file type that is able to be registered in the activated registration window according to contents; and
displaying an error message when one of the multimedia files that is dragged and dropped in the activated registration window according to contents does not have a file type that is able to be registered in the activated registration window according to contents.

23. The machine-readable medium of claim 22, wherein the inspecting comprises examining an extension of the multimedia file.

24. The machine-readable medium of claim 22, wherein the file information of the multimedia files includes address information of the multimedia files.

25. The machine-readable medium of claim 22, wherein the file information of the multimedia files includes Meta information of the multimedia files.

26. The machine-readable medium of claim 25, wherein the registering of the file information further comprises inputting the file information of the dragged/dropped multimedia file when the dragged/dropped multimedia file does not include the Meta information.
